(19) United States
(12) Patent Application Publication
(10) Pub. No.: US 2006/0259761 A1
(43) Pub. Date: Nov. 16, 2006

(54) Public Key Infrastructure (PKI) Information Encryption by a Non-Sender System

(76) Inventor: Vladimir Butenko, Tiburon, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/162,593

(22) Filed: Sep. 15, 2005

Related U.S. Application Data
(60) Provisional application No. 60/594,847, filed on May 11, 2005.

(51) Int. Cl. H04L 9/00

(52) U.S. Cl. 713/153

(57) ABSTRACT

A modified PKI encryption method and system provides improved security of information being transmitted between a sender system and a receiver system. An intermediate system which transfers the information between the sender and receiver systems can be configured to encrypt unencrypted information sent by the sender system. The intermediate system can be configured by a user of the sender system so that unencrypted information sent by the sender system is encrypted prior to being delivered to the receiver system. Alternatively, a user of the receiver system can configure the intermediate system to encrypt unencrypted information it receives from a sender system prior to the intermediate system storing the received information.

### CROSS-REFERENCE TO RELATED APPLICATION

This application claims priority of U.S. Provisional Application No. 60/594,847 filed May 11, 2005, which is hereby incorporated herein by reference.

### FIELD OF INVENTION

This invention relates generally to security of information being transmitted between different users. More specifically, the invention relates to a system and method for providing encrypted information even if the information has not been encrypted by the sender.

### BACKGROUND OF THE INVENTION

The Public Key Infrastructure (PKI) is the combination of software, encryption technologies, and services that enables enterprises to protect the security of their communications and information. PKI is widely known and deployed for many uses. It is described in many documents, including http://www.alw.nih.gov/pki/docs/AMG-Oct97-PKI/. One of the main applications for PKI is information encryption. PKI entries can have a pair of (relatively long) numbers, called private and public keys. While the private key is kept securely within the entry, its public key is made easily accessible for other entries.

PKI encryption is a mathematical operation involving a PKI key and some data. Security of PKI encryption is based on the assumption that a portion of data encrypted with a Public Key can be quickly decrypted only using the corresponding Private Key, and a portion of data encrypted with a Private Key can be quickly decrypted only using the corresponding Public Key.

Symmetric key (or “secret key”) encryption is a mathematical operation involving some (relatively long) number (the “secret key”) and some data. Information encrypted with the “secret key” can be quickly decrypted only using the same “secret key”.

PKI information encryption is usually implemented in 2 forms:

1) the PKI encryption option is applied to the information itself;

2) a random, relatively long, number is generated; it is used to encrypt the information using the symmetric key encryption with this number as the “secret key”; the “secret key” itself is encrypted using PKI encryption and the PKI-encrypted “secret key” is appended to the encrypted data to form a PKI-encrypted message. The appended data may contain the information (the ID) of the PKI entry whose key was used to encrypt the symmetric key. PKI keys of several entries can be used to independently encrypt the generated “secret key”, and several encrypted keys (possibly with the PKI entry IDs) can be appended to the message.

An example illustrating the above described PKI implementation can be seen in FIG. 1, which shows the secure data flow for a message being sent from a sender system to a receiver system. A portion of data (a “message”) can be transferred securely if the sender somehow learns the public key of the receiver, and then uses that public key to encrypt the message. If a message is sent to several receivers, the second PKI encryption method can be used, forming a single encrypted message that can be decrypted by several receivers.

Only the intended information receiver(s) who is in possession of the proper private key can decrypt the message, or it can decrypt the attached “secret key” and use that “secret key” to decrypt the message itself.

Many systems (such as E-mail and Instant Messaging) use various forms of the “store-and-forward” mechanisms. With these mechanisms, a message is stored on some intermediate computer system for a certain period of time. Messages can be stored in the computer's operating memory for several seconds (such as with Instant Messaging) or they can be stored in permanent memory for several minutes or hours (such as with E-mail relay servers, for example) or unlimited time (such as with E-mail storage/mailbox servers, for example). If a message was not sent encrypted, it can be accessed and read by someone who has obtained access (legally or illegally) to the storage on the intermediate computer system. Thus, a security risk is created.

Thus, there is a need to provide security to such intermediate computer systems in order to limit the time unencrypted transmitted information can be accessed by someone other than the intended recipient.

### SUMMARY OF THE INVENTION

The present invention is directed at a system and method for having these intermediate computer systems retrieve the public keys of the information recipients and encrypt unencrypted information upon receiving it, thus limiting the exposure of the unencrypted information to a part of the information path between the information sender and the encrypting intermediate computer systems.

In a first embodiment, the intermediate system is configured to encrypt unencrypted messages it receives from a sender system, prior to sending the message to a receiver system.

In a second alternative embodiment, the intermediate system is configured to encrypt unencrypted messages it receives from a sender system, prior to saving the messages on the intermediate system storage.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates the data flow for a PKI encryption process according to the prior art;

FIG. 2 illustrates the data flow for a PKI encryption process according to one embodiment of the present invention; and

FIG. 3 is the data flow for a PKI encryption process according to another embodiment of the present invention.

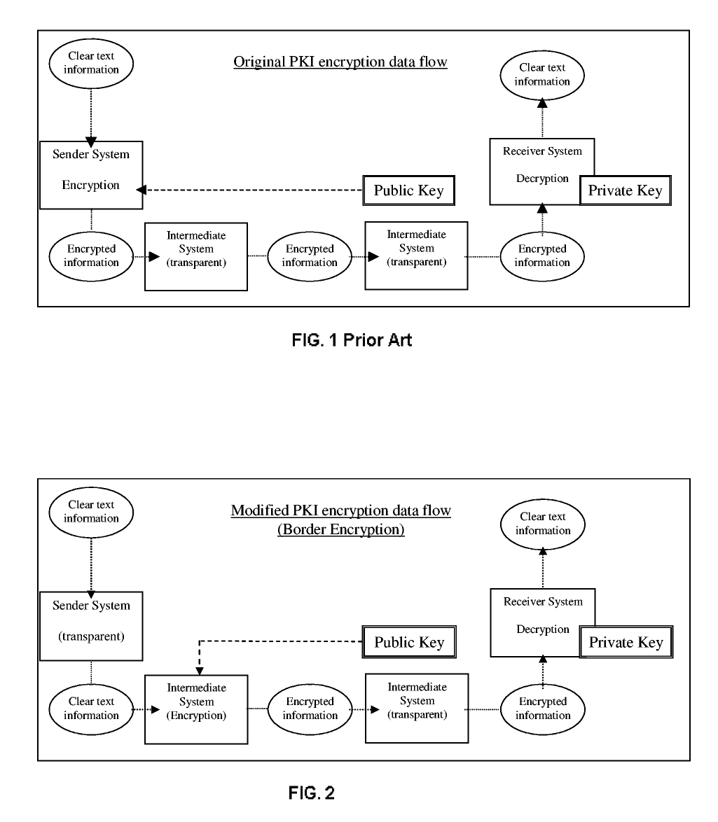

### DETAILED DESCRIPTION OF THE INVENTION

The following discussion describes embodiments of the present invention. This discussion should not be construed, however, as limiting the invention to those particular embodiments. Practitioners skilled in the art will recognize numerous other embodiments as well.

In general, the present invention is implemented using the intermediate computer systems. When such a system receives an unencrypted portion of data, the message, it checks its configuration settings and decides if the message is to be encrypted. It then tries to obtain the public key of the message's recipient(s) using the same or similar methods as those available to the sender system. If the public keys cannot be obtained, the message is either rejected or transferred without encryption, subject to the intermediate system's configuration settings. If the recipient(s) public keys are successfully obtained, the keys are used to encrypt the message itself, or a random “secret key” is generated, the message is encrypted using that “secret key”, the “secret key” is encrypted using the retrieved public keys, and the encrypted “secret key” data is attached to the encrypted message. The resulting encrypted message is transferred to the receiver system, or it is transferred to an intermediate system, or it is stored on the current intermediate system waiting for retrieval by the receiver system.

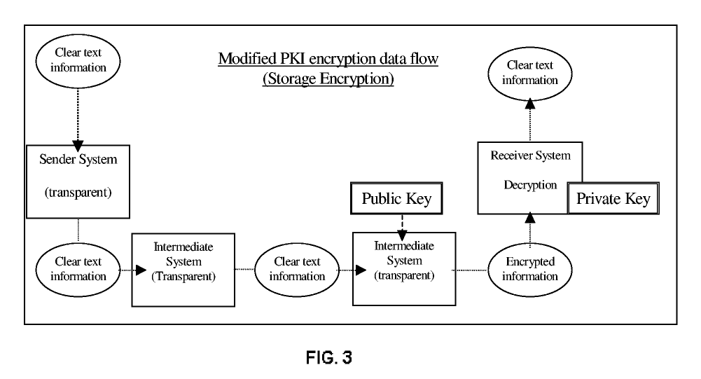

Referring to FIGS. 2 and 3, two embodiments of the present invention will now be described. The first embodiment shown in FIG. 2 illustrates a “border encryption” or “border controller” implementation. In this embodiment, as in the next embodiment, the intermediate system is an email server. Here, the intermediate system is configured to encrypt outgoing messages from the sender system that haven't been encrypted, before the intermediate system transmits the message to the receiver system. The intermediate system can be configured to encrypt all messages not encrypted, or messages for certain intended recipients.

In the second embodiment illustrated in FIG. 3, a “storage encryption” implementation is shown. Here, the intermediate system is configured by the receiver system to encrypt unencrypted messages received by the intermediate system, prior to the messages being stored in the intermediate system. As in the border encryption embodiment, the intermediate system can be configured to encrypt all unencrypted messages it receives, or only messages from particular senders. Thus, the messages stored at the intermediate system, for example in a user's email inbox, are encrypted and secured against someone other than user reading the email message.

The present invention provides advantages and benefits over prior art PKI encryption implementations. Prior solution architectures were designed to provide “end-to-end” security, thus they demanded that encryption takes place at the sender system. The proposed solution uses the same mechanisms (such as PKI, S/MIME and others) to improve data security in the situations where the message sender did not encrypt the information for any reason. On the other hand, there are solutions implementing information encryption for intermediate and storage servers. These solutions use various proprietary encryption methods, and do not use the standard encryption methods (such as S/MIME), as a result the encrypted information cannot be transferred in the encrypted form to a standard receiver system.

Additionally, the present invention allows an intermediate system (email server) to apply its centrally defined security policy and convert unencrypted messages it sends into an encrypted format. For example, the security policy can specify that all email messages sent outside the company network are encrypted.

A further benefit of the present invention is that it allows recipients to instruct their email servers to encrypt all or some of the incoming messages if they have not already been encrypted. Thus, all sensitive information stored in the email server mailboxes can be stored encrypted, decreasing the risk of unauthorized access by those who have access rights to the mail server storage data, but are not the intended recipient.

While the examples above are directed at an email environment, principles of the present invention can be implemented in other systems designed to provide end-to-end PKI-based security, such as, for example, secure instant messaging (IM) systems.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A method of managing received data in a data transmission and processing system, the method comprising:
receiving the data from a sender;
determining if the data is to be encrypted
retrieving an encryption key from a recipient, if it was determined that the data is to be encrypted; and
encrypting the data using the encryption key to produce encrypted data, wherein improved security is provided for the received data.

2. The method of claim 1, wherein the encryption key is a public encryption key.

3. The method of claim 3, wherein the public encryption key is generated by standard encryption methods consisting of PKI and S/MME.

4. The method of claim 1, wherein if an encryption key is not available from the recipient, the data received from the sender is either rejected or transferred without encryption subject to instructions given the data transmission and processing system by the recipient.

5. The method of claim 1, wherein after the retrieving step, the method comprising: generating a random secret key;
encrypting the secret key with the retrieved encryption key; and
encrypting the data using the secret key instead of the encryption key.

6. The method of claim 5, wherein data about the encrypted secret key is attached to the encrypted data.

7. The method of claim 1, wherein if the data is comprised of unencrypted information from the sender, the unencrypted information is encrypted prior to being received by the recipient.

8. The method of claim 1, wherein the received data is received on an intermediate system having encryption instructions configured by a recipient.

9. The method of claim 8, wherein if the data is comprised of unencrypted information from the sender, the unencrypted information is encrypted prior to being stored in the intermediate system.

10. The method of claim 9 wherein the intermediate system encrypts data only for certain intended recipients.

11. The method of claim 9, wherein the intermediate system encrypts data only from certain senders.

12. A method of managing sent data in a data transmission and processing system comprising:
receiving the data from a sender;
determining if the data is to be encrypted;
retrieving an encryption key from a recipient, if it was determined that the data is to be encrypted;
and encrypting the data using the encryption key to produce encrypted data,
wherein improved security is provided for the sent data.

13. The method of claim 12, wherein the encryption key is a public encryption key.

14. The method of claim 12, wherein if an encryption key is not available from the recipient, the data received from the sender is either rejected or transferred without encryption subject to instructions given the data transmission and processing system by the sender.

15. The method of claim 12, wherein if the data is comprised of unencrypted information from the sender, the unencrypted information is encrypted prior to transmitting to the recipient.

16. The method of claim 1 5, wherein the received data is received on an intermediate system having encryption instructions configured by the sender.

17. The method of claim 16, wherein any unencrypted information of the received data, is encrypted prior to being transmitted to another intermediate system.

18. The method of claim 16, wherein the intermediate system encrypts data only for certain intended recipients.

19. The method of claim 16, wherein the intermediate system encrypts data only from certain senders.

20. A data transmission and processing system for enhancing data security comprising:
one or more senders for sending data;
one or more intermediary computer systems for processing said data,
one or more recipients for receiving said data;
wherein a determination for encryption is provided for data sent to an intermediary system and if encryption is determined, an encryption key is retrieved from the corresponding recipient for encrypting the data to produce encrypted data, prior to transfer to or retrieval by the recipient.

21. The system according to claim 20, wherein the determination for encryption is configured by a sender or a recipient.
